(19) United States
(12) Patent Application Publication
(10) Pub. No.: US 2005/0197955 A1
(43) Pub. Date: Sep. 8, 2005

(54) Method and apparatus for registering and amplifying a payment claim

(76) Inventor: Michael T. Rossides, Scottsdale, AZ (US)

Correspondence Address: MICHAEL T. ROSSIDES, 11167 E. Mirasol Circle, Scottsdale, AZ, 85255, US

(21) Appl. No.: 10/792,964

(22) Filed: Mar. 3, 2004

(51) Int. Cl. G06F 17/60

(52) U.S. Cl. 705/40

(57) ABSTRACT

The invention is a method for operating a computer database system for the purpose of registering and probabilistically amplifying the value of a payment claim. A first module (sub-method) registers the identity of users who enter payment claims. A second module registers claims entered by users. A third module executes an expected value payment bet for each claim in which a claim has a 1/N probability of “winning.” A winning claim is worth N times the original value of the claim. If the claim is a winner, a fourth module assigns the claim an identifier and informs the user who entered the claim of the winning result and of the identifier. A fifth module enables a system operator to search the database of stored user identities and of stored claims to detect duplicate claim entries. The results of the method are that a winning claim is N times more valuable than when it was entered into the system, and that a winning claim is identified so that a claimant can retrieve it and pursue it further, outside the system. The invention is particularly useful for transacting claims for small amounts of money, as in many referral payment claims.

### CROSS-REFERENCES TO RELATED APPLICATIONS

This application makes reference to U.S. patent application Ser. No. 10/424,190, filed Apr. 25, 2003.

This application makes reference to U.S. Pat. No. 5,269,521.

### STATEMENT REGARDING FEDERALLY FUNDED RESEARCH

Not applicable.

### BACKGROUND

1. Field of the Invention

The invention relates to methods for enabling people to be paid a referral commission. More generally, the invention relates to enabling people to be paid on small claims.

2. Description of Related Art

Many methods exist and have been patented for using a computer database system to enable sellers to pay commissions to referrers. For example, U.S. Pat. No. 5,537,314 describes a “Referral recognition system for an incentive award program” that enables multiple companies to use a single payment system for accumulating and paying referral fees. A relatively recent innovation in the field of paying for referrals is called “automated affiliate marketing” in which a referrer puts an “affiliate link” on a website that leads to a seller's website. If an Internet user clicks on the link and buys from the seller's website, the owner of the referring website gets credited with an affiliate commission. This method is described in U.S. Pat. No. 6,029,141. A related U.S. Pat. No., 5,991,740, describes a network for managing website affiliates.

In order to pay a commission to a referrer, using a database system, a referral payment offer must be made. Further, assuming an offer exists, a referral claim must usually be registered. And further, the payer of the commission needs to register and verify that the referral led to a sale, as specified by the referral payment offer.

For example, in the case of an affiliate payment made to a website owner, a payment offer is made by a seller, outside of an automated referral link system. In accordance with the offer, a link is inserted into the owner's affiliate website. This link and the seller's site include programming that tracks/verifies whenever a prospect is sent to a seller's site from the affiliate site. The seller's site then registers whether a sale to that prospect took place. Thus, this kind of affiliate method registers that an affiliate site (the owner of the site, actually) has a referral payment claim, and further, registers (and implicitly verifies) that a sale was made to a prospect who came from the affiliate site. A separate process transfers the payment from the seller to the owner of the affiliate website.

This patent application discloses a novel method for lowering the average cost of both registering—submitting, that is—a payment claim and verifying that a referrer made a referral that led to a sale—that is, verifying that a referrer is owed the commission.

A key solution of the invention, not provided by any existing method or system, is that the invention does not requires a user to enter a claim such that the content of the claim is machine readable. Instead, the user only has to enter:
1. information that identifies him (which may be done automatically)
2. a minimal amount of content defining the claim, content that a human can understand, and enough content so that the claim can be verified using additional information provided in a separate verification process outside the invention.

In other words, many steps required for fully transacting a claim are cut out of the inventive method. Only the steps needs to identify and amplify a claim are included. By minimizing the initial effort required to submit a claim, the inventive method enables more kinds of claims to be transacted than by other methods.

The invention makes it cost-effective to pay for word of mouth recommendations. Sellers have long paid for word of mouth recommendations, but the methods for transacting payment are usually not cost-effective for most products and services. For instance, using current methods, it is not cost-effective for a company to pay a person for telling his friends, in conversation, about the merits of a particular soft drink. Because the invention lowers the average costs of submitting and verifying a referral claim, it enables sellers to pay for word of mouth recommendations of virtually any type of product or service.

The steps of transacting a referral payment can be generalized to other kinds of payment claims where:
1) A recipient must submit a claim for payment
2) The payer must verify that the conditions of the payment have been met.
   Hence, the inventive method can be broadened to apply to a variety of payment claims.

Integral to the inventive method is the expected value payment method (EVPM) of U.S. Pat. No. 5,269,521. While U.S. Pat. No. 5,269,521 discloses how the EVPM is used to transact payments, the patent does not describe the novel method disclosed in this application. In other words, this application disclosed a novel method that employs the EVPM.

This application describes some sub-methods in common with, or related to, those of application Ser. No. 10/424,190. Application Ser. No. 10/424,190 is incorporated by reference into this application in case the claims of this application should reflect both disclosures.

### OBJECT OF THE INVENTION

The object of the invention is to reduce the average cost of registering referral payment claims and, more generally, of registering a variety of payment claims.

### BRIEF SUMMARY OF THE INVENTION

The invention is a method for operating a computer database system for the purpose of registering and probabilistically amplifying the value of a payment claim. A first module (sub-method) registers the identity of users who enter payment claims. A second module registers claims entered by users. A third module executes an expected value payment bet for each claim in which a claim has a 1/N probability of “winning.” A winning claim is worth N times the original value of the claim. If the claim is a winner, a fourth module assigns the claim an identifier and informs the user who entered the claim of the winning result and of the identifier. A fifth module enables a system operator to search the database of stored user identities and of stored claims to detect duplicate claim entries. The results of the method are that a winning claim is N times more valuable than when it was entered into the system, and that a winning claim is identified so that a claimant can retrieve it and pursue it further, outside the system. The invention is particularly useful for transacting claims for small amounts of money, as in many referral payment claims.

### BRIEF DESCRIPTION OF THE DRAWINGS

There are no drawings.

### DETAILED DESCRIPTION OF THE INVENTION

### Contents of the Description

How this Specification Is Written

Incorporating U.S. application Ser. No. 10/424,190 by Reference

Context—Where the Inventive Method Is Applied

Initial Definitions

Module 1: Registering a Submitter's Identity

Module 2: Registering a claim
2a: Email Interface for Submitting (Registering) a claim
2b: Webform Interface for Submitting (Registering) a claim
2a: Voice Mail Interface for Submitting (Registering) a claim

Module 3: Executing EV Payment Bet for a claim, Storing Result

Module 4: Informing Submitter of Result, If Result Is a Win

Module 5: Searching Submitter and claims Databases to Detect Duplicate claims

Results (Products) of the Invention

Module 6: Enabling a Parlay Bet

Module 7: Finding a Payment Offer that Matches a claim

How this Specification is Written

This specification is organized as a set of descriptions of modules (sub-processes) that together comprise the inventive method. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Illustrative Examples

Example cases are provided. Those skilled in the art will know that these examples are illustrative only and do not limit the range of applications of the present invention.

Standardized Options

Many of the options described in this specification, such as the terms of EV payment bets, may be held standard in practice. Those skilled in the art will readily see where a user option may be converted into a default.

Context—Where the Inventive Method is Applied

Imagine that you have just recommended Hansen's Diet Lemonade to a friend. You do not know whether the friend will buy it and you do not know whether Hansen's, Inc. offers payments for recommendations that lead to sales. Do you want to take three minutes to do a lookup to see if Hansen's, Inc. offers a payment? Do you want to find out if your friend later bought Hansen's Lemonade? Do you want to ask the friend to provide proof of purchase in order to let you claim your referral fee?

Probably, you do not, unless the potential payment is large. More precisely, you probably only want to make an effort in which:
(projected value of effort)/(time of the effort)>a threshold.

In other words, you want the effort to be worth your while.

The inventive method enables you to register your claim in less than a minute, possibly amplify the value of the claim and, thereby, find out whether the claim is worth pursuing further. For many users, in a wide variety of cases, the inventive method makes:
(projected value of initial registration)/(time of initial registration)>a user's threshold.

Two essential steps in transacting a referral payment are to:
1. register a referral claim, stating that a particular referrer is owed the payment
2. register and verify that the referrer made a referral that led to a sale.

The inventive method lowers the average time cost of these steps. Thus, the method can be used situations where people do not want to expend much effort on these steps.

The method is implemented via an online computer database system, which we will call the inventive system or the system.

The method can be configured for use by referrers, buyers and/or sellers to register and amplify the value of a referral payment claim. We describe it mainly for use by referrers.

The basic idea is that a submitter enters a claim into the system. The system registers the claim and then executes a random number generation from 1-N. If the claim is a “winner,” it becomes worth N times the original referral payment offer amount.

The system alerts the submitter if the claim is a winner.

If the claim is a winner the submitter can take the steps necessary to continue pursuing the claim. These additional steps include submitting a variety of data—such as proof-of-purchase—that require more time than is required to submit the minimal data needed to determine simply whether a claim is to be amplified.

The minimal data required is just enough data to uniquely identify the claim so that additional data can be gathered later, if necessary.

For example, the inventive method enables a referrer to spend 30 seconds or less submitting a claim that he recommended Hansen's Lemonade to a friend.

Thus, the inventive method enables a user to expend very little effort on the initial step of submitting and, possibly, amplifying a claim.

Indeed, the referrer can use the method and system to register a claim even if the referrer does not know whether a referral payment offer has been made. This is a reason the method is useful. It allows a referrer to skip the effort of finding out if a seller is offering a referral payment, and instead, just register a claim. If the claim value becomes amplified by a multiple (N), then the referrer can look up whether an offer exists.

Thus, the inventive method is used in conjunction with additional, complementary methods for transacting a payment, but the inventive method is separate.

As discussed, the method can apply to many types of payment claims. For example, it can be used to register and amplify a claim for a rebate, a targeted discount, a reimbursement for an expense, a tax deduction, and a job payment.

We will describe how each module works for referral payment claims and broaden the description so that each module can be used for other kinds of claims.

The inventive method can reduce the following costs, on average:
1. the costs of registering claim data, including data identifying a submitter and identifying a claim
2. the costs of looking for a payment offer that may or may not exist
3. the costs of proving and verifying that the conditions required by a payment offer have been met, e.g., whether a referral led to a sale.

The projected value of a payment claim may be quite low, especially if the submitter is uncertain as to whether a payment offer even exists. Therefore, reducing the average cost of making the claim is often critical to having such a claim transacted at all.

Incorporating U.S. application Ser. No. 10/424,190 by Reference

The disclosure of patent application has some overlap with the disclosure of U.S. patent application Ser. No. 10/424,190, filed Apr. 25, 2003. Hence, U.S. patent application Ser. No. 10/424,190, filed Apr. 25, 2003 is incorporated by reference into this application.

Initial Definitions

Claim Amplification Method (CAM). The name we use to refer to the inventive method.

Submitter. A user who submits a payment claim using the inventive method or system.

Product. Any product or service.

Sale. Any kind of sale or purchase (any expenditure of money for some product). Sale is a broad term encompassing even such areas as selling a person on making a donation.

Buyer. A person who pays for a product. Buyer is a broad term encompassing even people in the role of donors. A buyer can be buying for herself or an organization.

Referrer. A person who makes a referral (recommendation) to a prospect. We will also call a referrer by the name Ray.

Referral Fee. A commission that is owed a referrer who meets specified conditions. The fee amount can be static or a percentage of a sale amount.

Offerer. A company (a seller or agency) that offers a payment, such as a referral fee. The offerer will be represented by a person, who we often refer to as the seller.

System Administrator (Operator). A person authorized to operate the inventive system and/or authorized to access all the data stored in the system. Also referred to as Sis.

### Module 1: Registering a Submitter's Identity

The inventive method (CAM) includes a user registration process in which a user enters “official” identity information and at least one user name.

In order for the inventive system to register a claim, the system needs to identify the submitter. Identification enables the system to inform the submitter that the claim he has submitted has “won.” Further, identification enables the system and a system administrator (Sis) to search for and detect duplicate submissions of a claim.

For example, assume Ray wants to submit a claim stating that he has told a friend that Hansen's Lemonade is delicious. How is the system to know whether Ray is making one submission or ten? And, how is the system to alert Ray if his claim is a winner? Ray must be identified.

The CAM includes the registration of two types of identification. An official, hard-to-fake ID is required so that a submitter cannot cheat the CAM. And, a user-friendly user ID is needed to make submitting easy.

Need for an Official ID

Official identification information, which we will call an official ID, will mean information that is hard for a person to fake—that is, hard to fake outside a computer database. This concept is well known. Such hard-to-fake data can include any government ID number (such as a driver's license number), address information, banking information, date of birth, and so forth. An official ID that is stored by the sytstem can include biometric ID data, such as a voiceprint.

An official ID is required to deter Ray from creating multiple identities that would enable him to make duplicate submissions under different names.

If Ray's claim is a winner and he attempts to collect the amplified claim amount, then he will have to prove his identity. This identity will have to match the official ID he has entered when registering his identity with the system.

Thus, the invention provides a method of (or system for): registering official identification data for a submitter in a user identification database.

Need for a User-Friendly User ID

The CAM should also enable Ray to have a user-friendly, user ID to identify himself to the system. A user-friendly user ID is needed to make it easy for Ray to submit his claim.

Thus, the invention provides a method of (or system for): registering a user ID that:
(a) a submitter uses to interface with the system, especially when submitting a claim
(b) is associated in the user identity database with the submitter's official ID.

The CAM can enable a submitter to have more than one user name. A user name might be different depending on whether the submitter uses email, a webform, or a phone to submit a claim.

We note that in certain cases, it is possible for a submitter's official ID and user ID to be the same, as when certain kinds of biometric data are used to authenticate a user. For example, a submitter's voiceprint could be his official ID and his user ID.

### The Need for Storing a Submitter's Contact Data

The system will also need to register a submitter's contact data in order to inform him when a claim he has submitted is a winner.

Thus, the invention also provides a method of (or system for) registering contact information for informing a user when a claim he has submitted in a winner.

A submitter's contact data can be different from the submitter's user name. Or, the contact data can be the same, as when an email address or phone number is a user name.

### Searchable User Identity Database

The user identity database will include means for searching by official ID and user ID, and for finding all the user names that are associated with an official ID. Thus, a system administrator (Sis) can find all of the user names associated with Ray's official ID.

For example, assume social security numbers are used as an official ID. And assume email addresses and phone numbers are user ID's. Then, by searching using Ray's social security address, Sis can find the email address and phone number that Ray has used when submitting claims. Conversely, she could search by one of Ray's user names to find Ray's social security number, and then search by the social security number to find Ray's other user names, if any exist.

Now, a user ID will be part of every claim. And, the claims database (see the description of Module 2 below) will also include means for searching claims by user ID. For example, assume that Ray's user ID is 202-333-3333, and another user ID is ray@mail.com. Then, Sis could search for his claims using his phone number and his email address. She will then find all the claims he submitted under these user ID's.

The phone number and email address would also be associated with Ray's official ID, so Sis could find all of the claims that are associated with Ray's official ID, which is the key to stopping duplicate claim submissions.

Note: Payoff Preference can be Registered Too

We note that as part of the user registration process, the invention can provide for enabling a submitter to enter his preferred payoff multiple, such that EV payment bets for the submitter's claims are decided with a random number generation for I-N, where N is set by the user.

### Module 2: Registering a Claim

The invention includes a module for registering a claim, for enabling a user to submit a claim, that is, and for storing that claim in a database of claims.

Whether a submitter is a referrer or a buyer or a user submitting any kind of claim, a claim will comprise:
the submitter's user ID
content that the user enters
a timestamp (added by the system when the claim is entered).

The inventive system stores this information as a claim.

The inventive system's front-end will limit the length of the claim content.

The inventive system can include variety of front-ends for receiving a claim via web form, email, text message, and/or interactive voice response.

One important aspect of the CAM is that in its basic embodiment the front-end of the inventive system will not include an interface that classifies/labels the content into data fields. In other words, in the basic embodiment of the CAM, a claim is a “free-form” chunk of information that is not sub-divided into different pieces of data/information.

Thus, a claim is like an email message in the sense that a database that stores an email will store the sender's address, will timestamp the email, and will store the content of the email, but will not necessarily classify the content in any way.

Because it is not classified or analyzed, the claim is not matched up with any pre-existing payment offer. It is not registered by the system, that is, as an acceptance of a specified payment offer. It is a statement entered by a submitter and stored in a claims database.

Now, a submitter will have to enter certain information if he wants to the claim to be found valid during a separate inspection stage (that occurs outside the inventive method). This required information, though, is not verified and not necessarily labeled during a submission of a claim.

Labeling and Classifying the Content of a Claim

Labeling (classifying) the information in a claim may be useful in certain embodiments of the inventive method.

To classify the content, the system that stores the data can include an email parser, a text message parser, a webform, or an interactive voice form for enabling a submitter to both enter a claim and describe the contents of the claim such that the content can be labeled in a database.

The content can be labeled by type of claim. This kind of labeling is useful if the inventive system is used to store different kinds of claims, such as referral claims submitted by referrers, referral claims submitted by buyers, referral claims submitted by sellers, or a wider variety of types of claims, such as a rebate claims, expense claims, job payment claims, and so forth.

Below we will describe an embodiment of “Module 2” configured for use by a referrer submitting a claim for a referral fee, in which the referral claim information is “labeled.”

In this embodiment, the front-end of the database system that takes in the claim can enable a referrer to submit the key facts of a referral claim, which the system can register (label) including:
the potential buyer that the referrer has made the recommendation (referral) to
the product and/or the seller that the referrer has recommended.

The inventive system stores this information as part of a claim.

For example, assume that Ray has recommended Hansen's Lemonade to Mary. He can then access the inventive system, enter his user ID, state that he spoke to Mary and, state that he recommended that she try Hansen's Lemonade. The system will register this information, timestamp it, and store it such that it can be found.

A “minimal” set of information needed to describe a claim may be favored in practice because it requires the least amount of time to enter. There is no perfect way to define minimal. In practice, the information registered will depend on balancing the ease of entering a claim against the value of having more information describing the claim.

Note that in many implementations of the CAM, a user's ID will be automatically registered when he submits a claim. If an email address is the user ID, the system can automatically register that user ID when the submitter sends and email with the claim information. Likewise, if a browser “cookie” or equivalent identifier is the user ID, then the system can register that user ID when the submitter submits a webform with the claim information. Likewise, if a phone number is the user ID, the system can automatically register that user ID when a submitter leaves a voicemail with the claim information. So, the only effort a referrer will often have to make is to enter the product and/or the seller he recommended and, enter the name of the person he made the referral to.

The system can enable a referrer to enter additional claim information that the system registers including:
whether the buyer is buying for her own behalf or for an organization
the date of the referral
the submitter's desired payoff
the fact that submitter is acting in the role of a referrer.
   Enabling a Buyer to Submit a Claim

The module can be configured to enable a buyer to submit a claim for a referrer. Why would a buyer submit such a claim? One reason is that the referrer might not be able to, as when the referrer is a medium that makes a referral without knowing who has received the referral (for instance, a magazine review of a product). A second reason is that a seller could offer a buyer a share of the referral fee. A third reason is that the referrer could offer a buyer a share of the referral fee.

If a buyer is submitting a claim then the system can register the following information as part of the claim (in addition to the essential information described above):
the name of the referrer who made the recommendation (referral)
the product that the buyer bought and/or the seller that the buyer bought from.

For example, assume that Barry has just rented an apartment from the Alban Towers, which was recommended by his friend Ray. Barry can submit a claim by accessing the system, entering his user ID, stating that he rented an apartment from Alban Towers, and stating that Barry recommended Alban Towers.

The system can enable additional information to be submitted to describe the claim, including:
whether the buyer is buying for her own behalf or for an organization
the date of the referral
the submitter's desired payoff
the fact that he is acting in the role of buyer, rather than referrer
the fact that he is an individual or a business buyer
the date of the sale
the amount of money spent in the sale.
   Enabling a any Kind of Claimant to Enter a Claim

As discussed, the inventive method can be applied to register and, probabilistically amplify the value of any claim. Thus, the CAM includes a module for enabling a submitter to enter (in addition to the essential information described above):
the key facts of the claim—that is, enough information to allow an inspector to verify, if necessary, whether the claim is valid
the money amount of the claim, if that amount is known
the purchase amount, if a purchase amount is involved
the payoff desired.

For example, a user who wants to claim a 25-cent rebate on a purchase of four EverReady D batteries could enter:
his user ID
a description of what was purchased—the EverReady batteries in this case
the amount spent
the date of purchase.

This information could be enough to constitute a valid claim that could be verified at a later date if the 25-cent rebate were amplified, say, by a factor of 1,000.

As another example, a user who wants to claim a reimbursement (or tax deduction) for the expense of buying a $4 business magazine could enter:
his user ID
a description of what was purchased—the magazine in this case
the amount spent
the date of purchase.

This information could be enough to constitute a valid claim that could be verified at a later date if the $4 expenditure were amplified, say, by a factor of 1,000.

As another example, a user who wants to claim a $5 payment for a small job, such as the job of cleaning up litter at a playground could enter:
his user ID
a description of the job that was performed—the cleanup in this case
the amount of payment claimed
the date that it was performed.

This information could be enough to constitute a valid claim that could be verified at a later date if the value of the $5 job were amplified, say, by a factor of 1,000.

As noted above, the task of submitting a claim is made easier because the submitter's user ID would usually be registered automatically when he submits a claim.

Also as noted above, the CAM can provide for enabling a submitter to enter the payoff amount, as a static amount or as a multiple of the claim's initial value.

Also as noted above, the CAM can also provide for enabling a user to state his role in submitting a claim, i.e., whether the user is the claimant or whether the user is submitting a claim on behalf of the claimant, and if so, the submitter's relationship to the claimant.

Email Interface (or Text Message) Method of Submitting a Claim

The inventive method can enable a user to submit a claim via email. We will use the term “email” to encompass conventional email messages along with a variety of text messaging methods, including instant messaging or text messaging via cell phone.

Ray's email address can act as his user ID (if a text messages is used, the user's cell phone number or screen name can act as his user ID).

Ray can send a message to a specified system address where the system receives claim submissions.

The message can be natural language, e.g., “I recommended Hansen's Lemonade to Mary Rogers.” Or even simpler, “Hansen's Lemonade, Mary Rogers.”

Thus, we have a very easy way to submit a claim—a way that can take 15 seconds.

Webform Method for Submitting a claim

The inventive method can enable a user to submit a claim via webform.

The inventive system can enable Ray to open a particular webpage form (or an equivalent electronic form) and enter the claim information.

The system can recognize Ray via “cookie” or equivalent method, or Ray can be prompted to enter his user ID.

As with the email message, Ray can enter something as simple as, “Hansen's Lemonade, M. Rogers.”

Voice Mail Method for Submitting a Claim

The inventive method can enable a user to submit a claim via a voice mail.

Ray's phone number can act as his user ID.

The system can enable him to leave a voicemail that contains his claim information.

For example, Ray can call a system number that uses an interactive voice response (IVR) interface that enables Ray to enter, for instance, “I recommended Hansen's Lemonade to Mary Rogers.” The system stores the voice mail message, which is identified by Ray's phone number and by the time/date of the call, which the system automatically registers.

Identifying a Referral in the Media

The CAM enables people and media companies to be paid for referrals made in the media. In this case, the referrer does not know who received or acted upon the referral. For example, if a writer in a newspaper recommends a Sony Vaio computer, and a reader buys the computer as a result, then the writer cannot know that the buyer received and acted upon the referral.

The CAM and inventive system can include a front-end that enables a buyer to enter as part of a claim, the following information that is registered in labeled fields:
the name of the medium where the referral was made
the name of the individual, if any, who made the referral
the subject of the piece in which the referral occurred.

This sub-module was basically disclosed above, but we elaborate here to disclose how the CAM can be used as a novel method for aiding referral payments in which the referrer does not know who has received his/its referral, especially referrals made in the media.

### Module 3: Executing EV Payment Bet for a Claim, Storing Result

The invention will include a module for executing an EV payment bet for each claim that is submitted.

A claim will have a 1/N chance of being selected. If it is selected, then it will have a provisional value of N times its original value.

Thus, the payoff is a multiple, N, of the original value of the claim.

And thus, the CAM includes the step of executing an EVPM bet for a submitted claim in which the claim has a 1/N chance of being a “winner.”

For example, if the referral commission for recommending Hansen's Lemonade is 20% of an initial purchase, and the payoff multiple is 100, then the payoff is 2000% times the initial purchase. So, assume that Ray has recommended Hansen's Lemonade to Mary. And assume that she has bought as twelve-pack for $6. And assume that Ray has submitted a claim that wins. Then, he is eligible to be paid 2000%×$6=$120.

It is also possible for the payoff of the EVPM bet to be set as a static dollar or other currency amount. This option is possible when the submitter is a buyer who has reported the purchase amount and the referral fee (that is, when a submitter knows the initial value of the claim he is submitting).

Upon a winning result for a claim, the method triggers a module (see Module 4 below) for informing the submitter that the claim is a winner.

Note: the timing of the bet execution (random number generation) will depend on the implementation of the method.

In most implementations, the CAM will include the step of adding a claim ID to a claim, especially to a winning claim, so that the submitter can easily reference the claim. This claim ID is also for other users who will need find the claim to verify that it is valid.

For example, if Hansen's, Inc. offers a referral payment, and if Ray has submitted a claim that is a winner, then Hansen's will want to be able to find the original claim data to verify that Ray has fulfilled all the conditions of the referral payment offer.

Storing the Result of the EVPM Bet

The CAM will include the step of adding the payoff multiple to a winning claim (unless all winning claims have the same multiple) so that when the claim is retrieved, the multiple is shown with it.

Whether a claim is a winner or loser, the CAM will provide for storing the result along with the rest of the claim data.

It is important to keep losing claims so that they can be searched by automated means or by a system operator to detect whether a user is making duplicate submissions. If the system only stored winning claims then a user could submit multiple claims for the same referral (same payment claim) without having duplicate entries detected.

It is true that this cheat can be detected if a user has two winning claims for the same referral, so it is not strictly necessary to store winning and losing claims. But, it is more likely that the cheat will be detected if winning and losing claims are stored.

Thus, the method can provide for storing winning and losing claims such that they can be searched by any of the claim data entered, and including any additional data generated by the inventive method, such as the bet result.

Module 4: Informing Submitter of Result, if Result is a Win

The CAM will include a module for informing a submitter that his claim is a winner. The module will output just the claim ID to the submitter, so that the submitter can search the system to find the claim (including appended payoff multiple), and so that any other user a submitter tells about the claim ID can also find the claim. Or, the module can output the payoff multiple and other claim data along with the claim ID.

Accordingly, the invention will provide a method of (or system for): outputting to the submitter a claim ID and a payoff multiple for a winning claim.

(Note: It is not strictly necessary for a submitter to have a claim ID. Instead, the system can output all the claim data to the submitter.)

A user can be informed via email, or via a web page alert that would be on the submitter's “user account” web page, or via an automated phone call. Alternatively, if the user accesses the system via phone, the system can provide an alert that informs him that he has won, and supplies him with a claim ID that he can use to retrieve the claim data.

The timing of the alert is important. The period of time between submission of a claim and finding out if the claim is a winner will need to be long enough to allow a buyer to have made a purchase. For example, if Ray recommends Hansen's Lemonade to Mary, a period of time is necessary for her to make the purchase. If the buyer is the submitter, a period of time will still be necessary to prevent a “reverse-the-purchase” cheat in which a buyer can submit a claim, and if the claim is a loser the buyer reverses the purchase.

The timing of the alert will depend on the implementation of the invention and the type of claim being made. A submitter can be notified immediately upon submitting a claim in cases where no period of time is required between the submitting of the claim and the alerting of the submitter about whether the claim is a winner.

### Module 5: Searching Submitter and Claims Databases to Detect Duplicate Claims

As discussed above, the CAM will include a module for enabling a system administrator (Sis) to search the user identity and claims databases to detect duplicate submissions.

The CAM and the inventive system itself can also include algorithms for searching and detecting duplicates.

Sis or the system can check all the claims submitted by a submitter, using the submitter's user ID and official ID. The system can include algorithms for finding all of a user's claims this way, automatically.

In cases where the content of a claim is machine understandable, the system can include algorithms for automatically flagging duplicates.

However, as discussed, one of the advantages of the inventive method is that the content of a claim does not need to be machine-readable or machine-understandable. For example, a voice mail message might not be understandable by a computer.

Even where the content is machine-readable, the meaning of the content may not be machine understandable. A submitter could submit two claims that are duplicates for the purpose of making a claim—that are “synonymous,” that is—but that cannot be understood as duplicates by a machine. For example, Ray might submit a short claim such as, “Hansen's Lemonade, Mary Rogers,” and another claim, “Diet Lemonade Soda with Sucralose, M. R.” Both claims may have enough content to be a valid, and they might be duplicates, but a machine may not understand that, whereas a human may.

Thus, the invention can provide a method or (or system for) for enabling a system-authorized user to search by a submitter's user ID′ and a submitter's official ID to find all the claims submitted by the submitter.

The CAM can also include a step for assessing the submitter a charge for having his claims searched for duplicates.

(In this specification, we omit a description of a variety of well-known methods for charging users for using the system.)

The system can also enable Sis to put a flag in a submitter's user profile to state that the submitter is someone who has submitted duplicate claims. Such a flag can indicate the number of times that a submitter has been caught submitting duplicate claims.

This capability can be important, as a user's record can be used to assign privileges and penalties to the user. A user might be assessed a fine for submitting duplicates. Or, the user might be banned from using the system entirely.

Handling Referrals from Different Referrers

One aspect of the CAM is that, in some situations, more than one submitter may submit a claim for the same payment.

For instance, when referrers use the CAM, more than one referrer may enter a claim for a referral to the same prospect. Ray and Rick might both recommend Hansen's Lemonade to Mary. And, both Ray and Rick might submit claims.

The problem is that in certain embodiments the inventive system cannot understand that Ray's and Rick's claims are for a referral to the same prospect. The system cannot understand this fact if the system cannot “understand” the content of a claim.

Multiple claimants pose a problem for payers who do not want to make multiple, full payments, such as multiple, full referral fees. What if 10 people submitted a referral claim, for instance, for recommending Hansen's Lemonade to Mary?

One way to handle this situation is for a payer to offer a lower referral fee, to offset the possibility that multiple, legitimate claims will be submitted.

Another way to handle this situation is for the CAM to include algorithms for discounting a claim's chance of winning, based statistics collected about the frequency of multiple, legitimate submissions of claims for the same payment. In this case, Sis would enter a “discount factor” into the inventive system.

Deterring Cheating

While two or more people might legitimately submit a claim, it is also possible for users to cheat the method and system by submitting multiple claims in cahoots.

For example, assume that Mary knows she is going to buy Hansen's Lemonade within the next week. She contacts her friends Ray, Rick and Randy and tells them to submit a referral claim stating that each recommended Hansen's to Mary. Then there will be three claims submitted, each with a chance to be amplified. Alternatively, without Mary's knowledge, Ray can tell his friends Rick and Randy to submit claims because he has recommended Hansen's Lemonade to Mary and he knows that she is about to buy it.

There are ways to deter this cheat.

One way is to register when duplicate claims, submitted by different users, are winners. If two or more submitters have the same winning claim more than once (or more than a threshold number of times) then this “outlier” behavior can be detected, and the submitters can be flagged and penalized.

Or, if a given submitter has a winning claim in common with any other submitter more than a threshold number of times, that submitter can be flagged as someone who is trying to cheat the system.

A second way to stop this cheat, at least where referral claims are involved, is to register when duplicate, winning claims are for referrals made to the same buyer. If two or more submitters have the same wining claim, and for the same buyer, more than once (or more than a threshold number of times) then this “outlier” behavior can be detected, and the submitters and the buyer can be flagged and penalized.

A third way, which is outside the inventive method and system, is to ask the buyer who the most important referrer was. The referrer that the buyer says was most important can be the one to claim the payoff. If the buyer does not know that one of the referrers has won, then the cheat is deterred. In other words, if the buyer is not in cahoots with the referrers, then this method can deter the cheat.

We note that duplicated claims can be submitted when the CAM is used to process non-referral claims. For example, if a claim is for a payment for a job, more than one person can claim credit. If a claim is for using a business expense, such as a receipt for a business dinner, then more than one person can potentially claim the expense.

Flagging submitters who have winning, duplicate claims at a greater rate than average is a general way to deal with this cheating problem.

### Results (Products) of the Invention

The results—products—of the invention are amplified claims. An outputted, amplified claim is:
1. the claim information entered by a submitter and the claim information registered automatically by the system
2. a claim ID appended by the system
3. a multiplier stating how much the original value of a claim is to be multiplied by.

In addition, the products of the invention include a user identity database and a claims database. These databases are used to find claims, winning or losing. These databases are also used to detect duplicate submissions of the same claim.

Hypothetical Illustration of the Usefulness of the Products of the Invention

Using his cell phone, Ray dials 800-REFERRAL, and upon a prompt to enter his claim, he states, “Hansen's Lemonade, Mary Rogers.”

The inventive system logs his phone number to identify him and stores the voicemail message, identified by his phone number and the time/date.

One month later, the system executes a random number generation with the chance of the claim winning being 1/200.

The claim turns out to be a “winner.”

The next time Ray dials 800-REFERRAL, after the random number generation, he hears a voice message saying that one of his claims is a winner and that he should check his “My Account” page at the www.refer.com website.

He goes to the site and logs in, and finds that it shows a winning claim, identified by a claim ID and a multiplier, which is 200. He also sees a link to an audio file, which is his voicemail claim submission.

He plays the audio file and realizes that the claim is for a recommendation he made to his friend Mary Rogers to buy Hansen's lemonade.

At this point, he decides it is worth the effort to see if Hansen's even offers commissions for recommendations.

He goes to a website that lists company offers for referral commissions. He looks up the terms Hansen's and finds that Hansen's, Inc. does indeed offer a 20% commission. He realizes that he is owed 20%×200=4,000%=40 times the amount of the sale to Mary. He estimates that the amplified commission is worth around $400, if she spent around $10 on the Hansen's Lemonade.

So, he contacts Mary and asks her if she has bought Hansen's some time after he recommended it to her.

She says that she has and that she used her credit card, so she can provide proof of purchase.

They decide it is worth pursuing the claim and contact Hansen's.

Hansen's asks for Mary's proof of purchase, and asks for Ray's proof of referral.

Ray supplies Hansen's with Ray's claim ID, which is his proof of referral. An administrator at Hansen's, Inc. (or a system operator who is an agent for payers) then searches the claims database, using the claim ID, and finds the claim, which includes the multiplier, Ray's official ID, and an audio link to the claim, which the administrator can play to verify that Ray reported making the referral.

As this illustration shows, it can be quite useful to amplify the value of a claim using minimal claim information, before pursuing all the steps necessary to collect on a claim. The inventive method provides an efficient way to enable this kind of amplification.

Thus, a key to the utility of the invention is that the user only has to enter:
3. Information that identifies him so that he can be alerted when the claim value has been amplified. Note, that this user ID information can be entered automatically when a user interfaces with a system using the inventive method.
4. A minimal amount of content about the claim, content that a human can understand, and enough content so that the claim can be verified using additional information provided in a separate verification process outside the invention.

In other words, the steps required for fully transacting a claim are cut out of the inventive method. Only the steps needs to identify and amplify the claim are included. By minimizing the initial registration information/effort, the inventive method enables more kinds of claims to be transacted than by other methods.

Complementary System Outside of the Inventive System

If the invention were implemented successfully, one would expect that a complementary, although different method and system would be created for listing payment offers that potentially match amplified claims. A submitter with an amplified claim could then check to see if a matching payment offer exists. Such an offer database system could enable a submitter to take additional steps necessary to pursue an amplified claim, such as registering that the claim matches an offer in the offer database.

### Module 6: Enabling a Parlay Bet

A submitter may estimate that the amplifying multiplier is not enough to make an amplified claim worth pursuing. So, the CAM can include a process for enabling a submitter who has been alerted about a winning claim to request that another “parlay” bet be executed. The system will then execute the bet.

The probability of Ray winning such a parlay bet may be set by default, or the system can enable him to set the probability. For example, he might choose “double or nothing.”

The system then executes the parlay bet and informs the submitter immediately about whether he has won or lost.

If he has won, the payoff multiple is increased by a reciprocal of the probability of winning.

We note that a parlay option may also be mandatory because it can help to reveal cheaters. Cheaters will win a disproportionate number of bets compared to average, honest users. A process of multiple payment bets can enable the system's cheat detection algorithms to flag cheaters more quickly.

### Module 7: Finding a Payment Offer that Matches a Claim

Enabling a Submitter to Designate a Helper to Pursue a Winning Claim

A submitter may quite lazy. When he receives an alert that his claim is a winner, he may not know if a corresponding payment offer exists, and so, he may want to forward the claim to a designated “helper” who will check on whether a payment offer exists that corresponds to the claim.

For example, assume that Ray has submitted the following winning claim: “I recommended Hansen's Lemonade to Mary Rogers.” And assume that Ray does not know whether Hansen's, Inc. pays referral fees. Rather than check for himself whether Hansen's has a referral fee offer, Ray can pay someone else to check for him.

Payment offers are outside of the inventive method and system so it might be helpful for Ray to hire someone to find out whether an offer exists to match his claim and whether the claim is valid according to such an offer. Even if a payment offer exists that appears to apply to Ray's claim, the offer will include a host of conditions, so it may be worthwhile for Ray to pay someone else to check whether his amplified claim is valid.

Ray can simply send a friend his claim ID, and let the friend check on whether the claim matches an existing payment offer.

However, he might want to hire someone to do the work. So, the CAM can include a process for enabling Ray to send a “request for help” along with a claim ID to a designated, system-known “helper.” They system could thus include a class of users who are “helpers,” who check on winning claims, for a fee. The CAM can also include a process for enabling Ray to automatically forward all winning alerts to a system-authorized user who specializes in following-up (pursuing) claims.

The CAM can also provide steps for enabling a system-authorized user to check for Ray.

And the CAM can provide steps for making it easy for Ray to pay the helper a fee, which may be standard or negotiated. The fee may be in definite dollars or may be a share of any money collected.

Providing a Submitter with Payment Offers that Possibly Match a Claim

If a database of payment offers exists outside the inventive system, then the inventive system can include algorithms for analyzing the content of a winning claim and further include a process for matching the content of the claim against payment offers in this outside database.

This matching process might yield a list of potentially matching payment offers, or yield no matches.

Hence, if the inventive method and system provide algorithms for classifying claim content and matching it against payment offers in an outside database, then the inventive method and system can also provide for outputting to the submitter (or a submitter's designee) a winning claim's ID and a list of potentially matching payment offers.

This list of potentially matching offers can save the submitter the time of trying to find out if any matching offers exists.

Such a list will not be guaranteed, though.

As noted, it is possible for the submitter to designate that such a set of matches be outputted a designated user who can then pursue the winning claim further.

A designated user can, in certain cases, be a media company. The invention method can include a process by which a submitter who has submitted a referral claim on behalf of a medium can designate that if the claim is a winner, the claim should be sent to a designated representative for the medium, or to an automated process for informing a representative of the medium, who can then pursue the claim further.

Thus, a buyer might enter a claim that states the name of a medium. Assuming the claim is a winner, the inventive system can find the name of the medium in the claim content, and then the system can send the ID of the winning claim to a representative of the medium, who can then pursue the claim further.

1. a method for registering and probabilistically amplifying a payment claim, using an online computer database system, comprising the following steps:
registering the identity of submitters who enter payment claims in a user identities database, said identity including an official identity and at least one user name,
registering claims entered by submitters in a claims database, a claim being comprised of at least:
a submitter's user name,
free-form content,
a timestamp,
executing an expected value payment bet for each claim in which a claim has a 1/N probability of “winning,”
if the claim is a winner:
assigning the claim an identifier,
outputting the claim identifier and the payoff multiple (N) to the submitter,
enabling the submitter to search the claims database using the claim identifier to output said claim content,
enabling other users to search the databases of stored user identities and claims using the claim identifier,
enabling a system administrator to search the user identities and claims databases to find all the claims submitted under a given user name and under a given official identifier.

2. the method of claim 1 in which the claim content is entered via a voice mail.

3. the method of claim 1 in which the claim content is entered via an email.

4. the method of claim 1 in which the claim content is entered via a text message.

5. the method of claim 1 in which the claim content is entered via an instant message.

6. the method of claim 1 in which the claim content is entered via a webform.

7. the method of claim 1 in which the claim identifier is outputted to a user designated by the submitter.

7. the method of claim 1 in which the content of the claim is entered into labeled data fields.

8. the methods of claim 1 and 7 in which a winning claim triggers an algorithm for matching the content of the claim against payment offers in a database of payment offers to yield a list of potentially matching payment offers, and outputting said list of matching payment offers, along with the claim identifier, to the submitter.

9. the methods of claim 1 and 7 in which a winning claim triggers an algorithm for matching the content of the claim against payment offers in a database of payment offers to yield a list of potentially matching payment offers, and outputting said list of matching payment offers, along with the claim identifier, to a user designated by the submitter.
